(19) United States
(12) Patent Application Publication
(10) Pub. No.: US 2025/0243047 A1
(43) Pub. Date: Jul. 31, 2025

(54) CARBONATOR AND COLD-PLATE SYSTEM

(71) Applicant: Marmon Foodservice Technologies, Inc., Osseo, MN (US)

(72) Inventors: Shishirdas Kasaragod Ravindran, Chicago, IL (US); Zachary Dresser, Batavia, IL (US); Andy J. Tobler, Geneva, IL (US)

(73) Assignee: Marmon Foodservice Technologies, Inc., Osseo, MN (US)

(21) Appl. No.: 19/039,308

(22) Filed: Jan. 28, 2025

Related U.S. Application Data
(60) Provisional application No. 63/627,536, filed on Jan. 31, 2024.

(51) Int. Cl. B67D 1/00

(52) U.S. Cl. CPC B67D 1/0064; B67D 1/0065

(57) ABSTRACT

A beverage dispenser includes a cold plate with a plurality of fluid lines running through it. A cover includes a carbonator housing and a hopper cradle, with a cover aperture extending through the hopper cradle. The cover and cold plate together define a cooling chamber. An ice hopper, which has a hopper aperture, is connected to the cover at the hopper cradle, aligning the hopper aperture with the cover aperture so that cubed ice in the ice hopper can fall through the hopper aperture onto the cold plate. A carbonator is received through the cover into the carbonator housing.

### CROSS-REFERENCE TO RELATED APPLICATION

The present application claims priority of U.S. Provisional Patent Application No. 63/627,536, filed on Jan. 31, 2024, the contents of which are incorporated by reference herein in its entirety.

### BACKGROUND

The present disclosure relates to the field of beverage dispensing. More specifically, the present disclosure relates to cold-plate systems for cooling a carbonator in a beverage dispenser.

Beverage dispensers, as may be used in convenience stores, fast food service, concession stands, cafeterias or the like, operate to fill individual receptacles with beverages for customers. Such beverage dispensers combine concentrated flavoring (syrup) with a still or carbonated water diluent to produce the dispensed beverage. Customer preference and operational performance favor the beverage to be dispensed in a chilled state. In general terms, water of a lower temperature can entrain a greater amount of carbon dioxide (CO2) gas, providing a more carbonated beverage. Customers of carbonated beverages thus typically prefer a more carbonated and colder beverage compared to a warmer and flatter beverage.

Cold plates are used in beverage dispensing to provide heat exchange cooling of various drinks prior to dispense. The cold plate itself is constructed of a thermally conductive material and cooled by a volume of ice placed in contact with it, and in turn provides for cooling of beverage liquids circulated through tubes embedded in the cold plate. In situations where a cold plate is used in conjunction with a post-mix beverage dispense, sources of carbonated water and beverage syrup flavoring are connected to the cold plate to be cooled as they pass through the cold plate. A carbonated drink is then produced when the cooled carbonated water and syrup flavoring constituents are subsequently mixed together and dispensed from a post mix valve.

U.S. Pat. No. 6,945,070, entitled “Ice Cooled Cold Plate and Carbonator,” discloses a beverage cooling system for an ice and beverage dispenser with a carbonator tank mounted to a cold plate and is incorporated by reference herein in its entirety. The cold plate is provided with carbonator tank supports for mounting the carbonator tank in intimate heat exchange contact with the cold plate. The carbonator tank is mounted sufficiently far away from the heat exchange surfaces of the of the cold plate that it does not interfere with ice contacting the heat exchange surfaces. A cover encloses the cold plate and defines therewithin a cold plate compartment that resides beneath the ice retaining bin and forms a protected ice retaining space above the cold plate and heat exchange top surface.

### BRIEF DISCLOSURE

A beverage dispenser includes a cold plate with a plurality of fluid lines running through it. The cover includes a carbonator housing and a hopper cradle, with a cover aperture extending through the hopper cradle. The cover and cold plate together define a cooling chamber. An ice hopper, which has a hopper aperture, is connected to the cover at the hopper cradle, aligning the hopper aperture with the cover aperture so that cubed ice in the ice hopper can fall through the hopper aperture onto the cold plate. A carbonator is received through the cover into the carbonator housing.

The cold plate further includes a front stanchion and a rear stanchion, both integrally formed with the cold plate and designed to engage the body of the carbonator. These stanchions are within the carbonator housing defined by the cover. The cold plate also defines a basin configured to receive cubed ice. An extension of the basin creates a cove between the front and rear stanchions. The cold plate has a lip that defines the basin's operative perimeter, and the cover is designed to engage this lip to form the cooling chamber. A ledge extends inside the lip, and the lower wall of the cover rests on this ledge. This ledge extends to the front and rear stanchions, defining a basin with a cove between them.

The cover has an opening into the carbonator housing, and the carbonator, which includes a body and a top end, is received within the cooling chamber. The cover has a detent that engages the body of the carbonator, placing the body in contact with the front and rear stanchions. The carbonator has a mounting plate secured to its top end, and a mounting frame is attached to the exterior of the carbonator housing around the opening. This opening is designed to receive the body of the carbonator, and the mounting plate is secured to the mounting frame. The mounting frame has an aperture aligned with the opening and an annular groove containing an elastomeric gasket, which engages the mounting plate to create a seal. The mounting plate is secured to the frame with at least one fastener, and an insulation pad is attached to the mounting plate's exterior face.

The carbonator's top end includes a water inlet, a gas inlet, and a carbonated water outlet, with the outlet fluidly connected to one of the cold plate's fluid lines. The hopper cradle is curved across a lateral dimension, and the cover and hopper apertures increase in height vertically above the cold plate in a wing towards the carbonator. The cold plate's front and rear stanchions engage the carbonator's body, and the basin's extension creates a cove between them. The wing exposes the carbonator's body and the cove to ice from the hopper through the cover and hopper apertures.

### BRIEF DESCRIPTION OF THE DRAWINGS

FIG. 1 depicts a beverage dispenser.

FIG. 2 depicts an interior of a beverage dispenser.

FIG. 3 is a perspective view of a cold plate.

FIG. 4 is a top view of a cold plate.

FIG. 5A is perspective view of a carbonator and cold plate.

FIG. 5B is a top view thereof.

FIG. 6A is a perspective view of a cover.

FIG. 6B is a top view thereof.

FIG. 7 is a perspective view of a cold plate and cover.

FIGS. 8A and 8B are front and rear perspective views of a mounting frame.

FIG. 9 is a left front perspective view of a carbonator, cover, and cold plate.

FIG. 10 is a right front perspective view of the carbonator, cover, and cold plate.

FIG. 11 is a sectional view taken along line 11-11 of FIG. 2 or 13.

FIG. 12 is a sectional view taken along line 12-12 of FIG. 11.

FIG. 13 is a top view of a hopper.

FIGS. 14A and 14B are demonstrative views of insertion of the carbonator.

### DETAILED DISCLOSURE

A beverage dispenser 10 is an example of a beverage dispensing machine, for example as generally described in US 2023/0141811, entitled “Beverage Dispensing Machine with Cup Dispense,” which is incorporated herein by reference in its entirety. The beverage dispenser 10 generally extends between a front 12 and a back 14, and between two opposed sides 16 and 18. The opposed sides 16 and 18 and the back 14 may be generally defined by an exterior cladding 15. The beverage dispenser 10 includes a graphical display 20 which is operable to present a user interface 22. A cup carousel 26 is configured to receive a cup from a cup dispenser 24 dispense a beverage therein. In addition to dispensing a cup and a beverage from a variety of cup sizes and beverage selections, the beverage dispenser 10 is also configured to retain a supply of ice and dispense the ice into the cups along with the ordered beverage. Pending U.S Patent Application Publication No. 2024/0191927, entitled “Ice Dispensers,” and which is incorporated by reference herein in its entirety, discloses systems and methods for ice dispensing in a beverage dispenser 10.

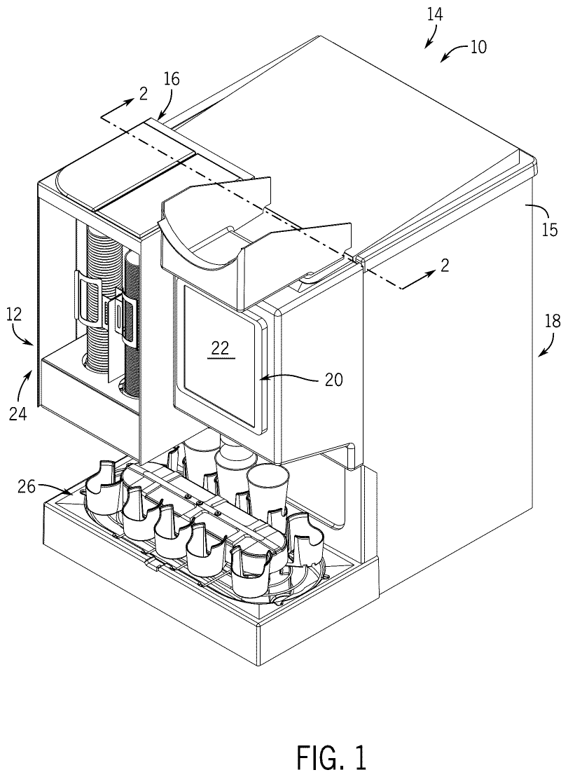

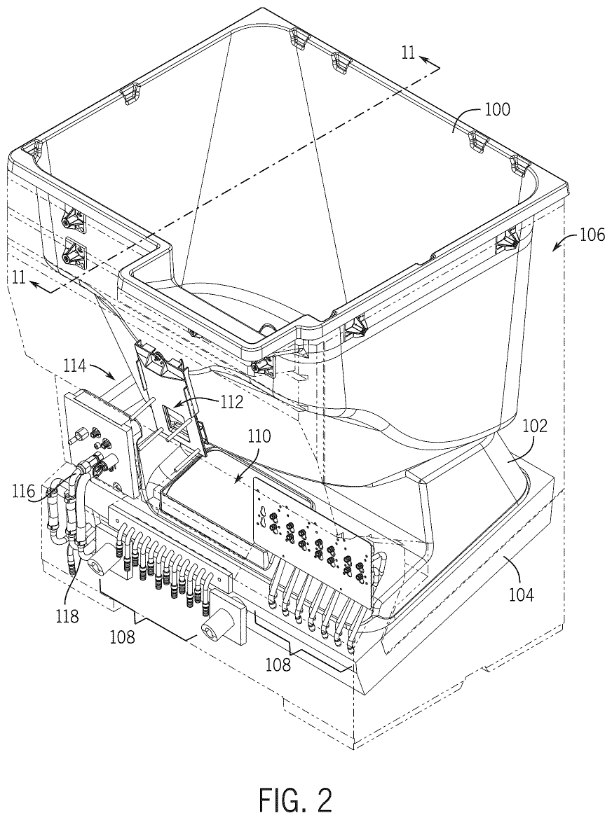

FIG. 2 depicts an interior of the beverage dispenser 10 taken at approximately line 2-2 and with the exterior cladding 15 of the beverage dispenser 10 removed. In this view, an ice hopper 100 is configured to receive a supply of pre-made ice. The ice hopper 100 is vertically stacked above a cover 102 which rests upon a cold plate 104. As is for example described in U.S. Pat. No. 6,945,070, foam insulation 106 (shown in shadow) fills in the space between these components and the exterior cladding (15, FIG. 1) of the dispenser 10. As noted above, pre-made ice is received in the hopper 100 and is directed through apertures, as will be described herein, to rest upon the cold plate 104. The cold plate 104 is constructed of a thermally-conductive material, for example, but limited to, cast aluminum.

The cold plate 104 includes a plurality of fluid lines 108 which are configured to carry flavoring syrup, still water, carbonated water, or premixed beverages therethrough. These fluid lines 108 extend through the cold plate 104. The ice resting on the cold plate 104 cools the cold plate, and the cooled cold plate in turn cools the fluids as they pass within the fluid lines 108 through the cold plate 104. While not depicted for the sake of clarity, a mechanical auger or agitator may be positioned in space 110 and extend into the hopper 100 to keep the ice held therein free-flowing and to break up any bridging. Movement of the ice within the hopper helps to fill a chute within the hopper 100 whereby a portion of ice within the chute is dispensed through a gate 112 out of the hopper 100. A non-limiting example of a cold plate and a beverage dispense as may be used with the description herein may be found in US 2024/0262671, entitled, “Cold Plate Prechill Circuit” which is hereby incorporated by reference in its entirety.

As described above, beverage dispensers 10 typically form beverages by mixing a diluent such as still or carbonated water with one or more flavoring syrups. The beverage dispenser 10 includes a carbonator 114. The carbonator 114 includes a cylindrical body 62 which is exemplarily constructed of a conductive material, for example aluminum or stainless steel. The carbonator 114 receives a supply of still water at water inlet 116. The carbonator 114 receives a supply of carbon dioxide gas at gas inlet 115. Probe 119 and probe 121 provide a level sensor within the carbonator 114. The probes 119 and 121 define the “low” and “high” liquid levels in the carbonator 114, from which filling and stopping of filling of the carbonator (not depicted) is controlled. Relief valve 117 provides a mechanical limit on the pressure and/or liquid inside the carbonator 114.

The carbonator 114 functions to receive the incoming still water and entrain it with carbon dioxide to form carbonated water. The carbonated water exits the carbonator 114 through carbonated water outlet 118 and is routed back to one or more of the fluid lines 108 in the cold plate 104 to circulate the carbonated water within the cold plate 104 for further chilling prior to mixing the beverage to be dispensed. It will be recognized that in the example depicted, at least the gas inlet 115, water inlet 116, and the carbonated water outlet 118 extend through the top end 134 and the mounting plate 132 of the carbonator 114. The top end 134 is generally perpendicular to the cylindrical body 62 of the carbonator 114 and the top end 134, when the carbonator 114 is installed in the dispenser 10 as described herein faces towards the front 12 of the dispenser 10.

The inventors have recognized that while beverage dispensers as disclosed in U.S. Pat. No. 6,945,070 improved ice contact with the cold plate over prior designs, this came at the expense of less cooling of the carbonator. A colder carbonator results in water with a lower temperature. Water of a lower temperature can entrain a greater amount of carbon dioxide (CO2) gas, providing a more carbonated beverage, furthermore, this lower temperature water has less temperature differential to overcome to reach equilibrium with the temperature of the cold plate 104 when the carbonated water is routed back through the cold plate prior to dispense, resulting in a more efficient operation of the cold plate 104. These and other benefits are provided in the carbonator and ice system as described in further detail herein.

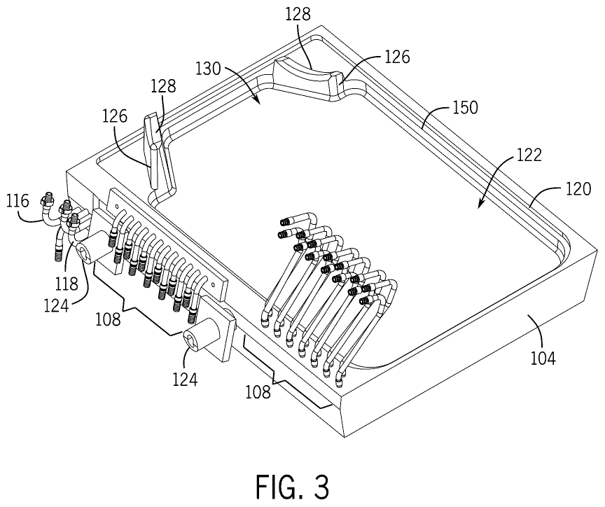

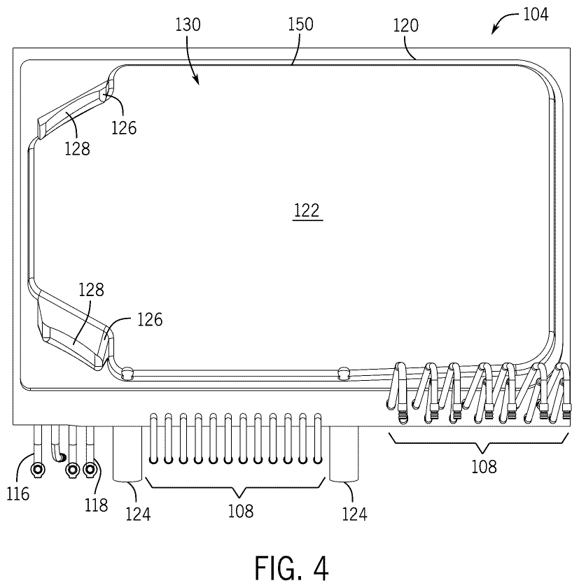

FIG. 3, a perspective view, and FIG. 4, a top view, depict an example of the cold plate 104 in isolation. The cold plate 104 includes a lip 120 that extends about an operative perimeter of the cold plate 104. The lip 120 defines a basin 122 within which the cubed ice rests in physical contact with the cold plate. The cold plate is exemplarily arranged at an angle, sloping towards the front at an angle of for example 45 degrees or less, or 30 degrees or less. One or more drains 124 connect through the cold plate 104 to direct melted ice water out of the basin 122. Stanchions 126 extend vertically from the basin 122. It is noted that the lip 120 exemplarily defines a perimeter exterior of the stanchions 126. It is further noted that the basin 122 generally follows the lip 120, but the basin 122 includes an extension 130 between the stanchions to the lip 120 on a carbonator-side of the cold plate 104. Each stanchion 126 exemplarily includes a cradle 128 configured for physical contact with the carbonator (not depicted). The stanchions 126 are exemplarily constructed of the same material as the rest of the cold plate 104 and therefore have the same thermally-conductive properties to be chilled by the ice and in turn to cool the carbonator in contact with the stanchions 126. It will be recognized that since the cold plate 104 is generally angled and the carbonator 114 generally held horizontally, that the front stanchion 126 extends vertically higher than the rear stanchion 126 to accommodate this angle while exemplarily maintaining the carbonator 114 in the generally horizontal position.

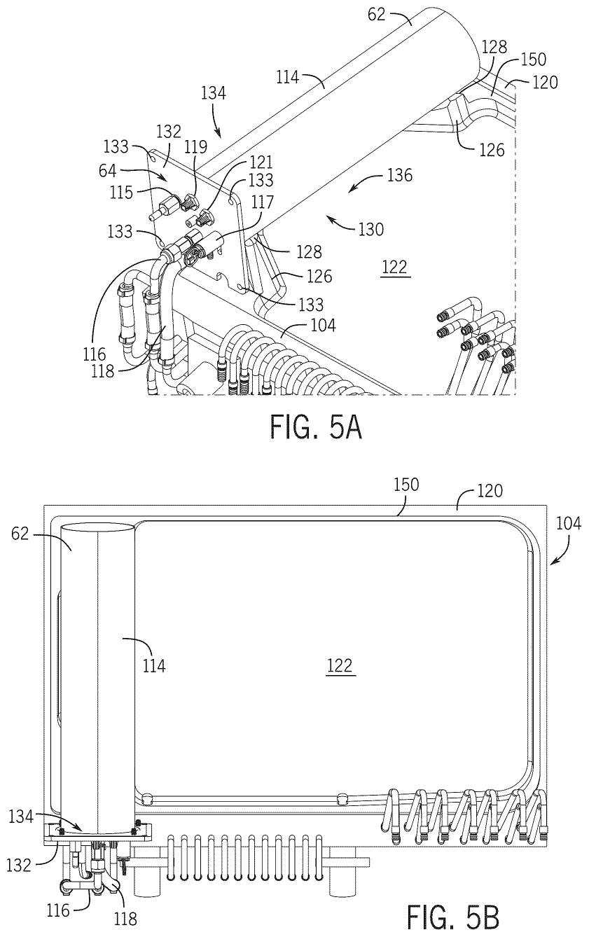

FIG. 5A, a perspective view, and FIG. 5B, a top view, depict the carbonator 114 in position on the stanchions 126 of the cold plate 104. The carbonator 114 includes a mounting plate 132 secured to the top end 134. The water inlet 116 and the carbonated water outlet 118 extend through the mounting plate 132. The extension 130 of the basin 122 defines a cove 136 between the cold plate 104 and the carbonator 114.

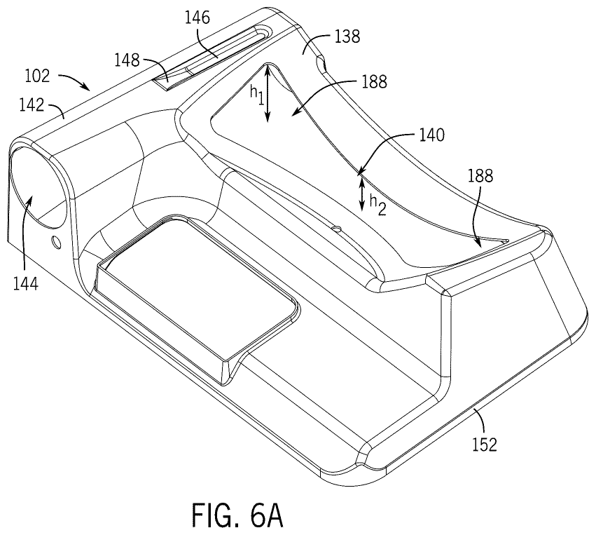

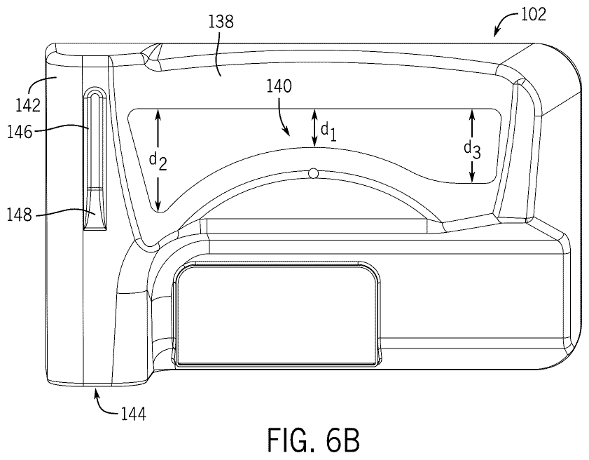

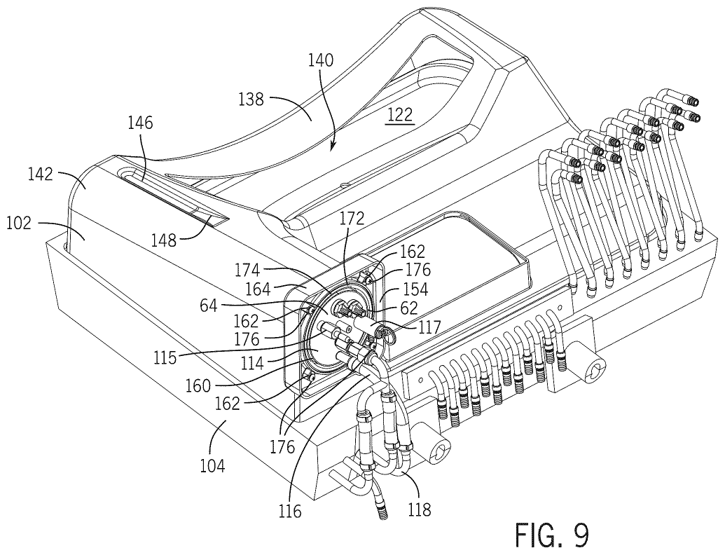

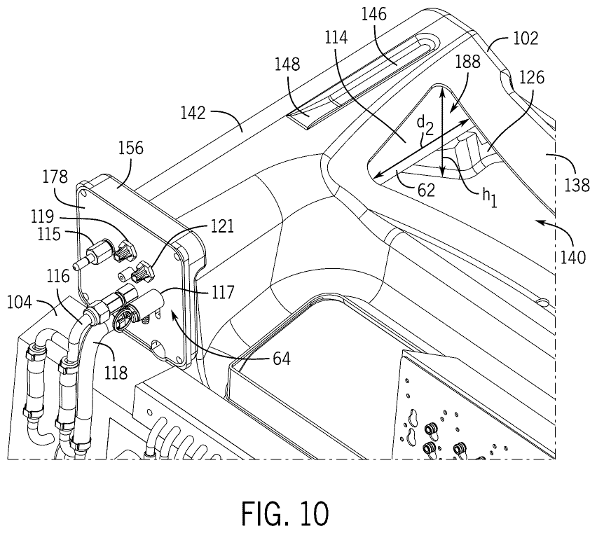

FIG. 6A, a perspective view, and FIG. 6B, a top view, depict the cover 102. The cover 102 includes a hopper cradle 138 with a curved surface in the lateral dimension across the dispenser 10 and is shaped and dimensioned to match and engage with a similarly shaped bottom 182 of the hopper 100. Exemplarily, when viewing the beverage dispenser 10 from the front 12, the hopper cradle 138 and the bottom 182 of the hopper generally form an arc. The cover 102 further includes a cover aperture 140 within the hopper cradle 138, through which cubed ice is received from the hopper 100 as will be described in further detail herein. A portion of the cover 102 defines a carbonator housing 142. The carbonator housing 142 is exemplarily at least partially dome shaped and arranged along one side of the cover 102. In an example, the hopper cradle 138 and the cover aperture 140 extend into the carbonator housing 142. The carbonator housing 142 further includes an opening 144 which is configured to receive a carbonator therethrough. The carbonator housing 142 of the cover 102 further includes a detent 146. The detent 146 exemplarily extends interior from an outside perimeter of the cover 102 into the carbonator housing 142. The detent 146 is exemplarily elongated in a direction of a corresponding elongated axis of a carbonator (not depicted) when inserted through the opening 144 (see e.g. FIGS. 9 and 10). The detent 146 includes an incline 148. As the carbonator 114 is inserted into the opening 144 and interior of the carbonator housing 142 to rest on the stanchions 126 (FIG. 5A), the cylindrical body 62 engages the incline 148 on an interior surface of the cover 102 which places force against the cylindrical body 62 of the carbonator 114 to position the carbonator 114 in the cradles 128 and in thermal contact with the stanchions 126.

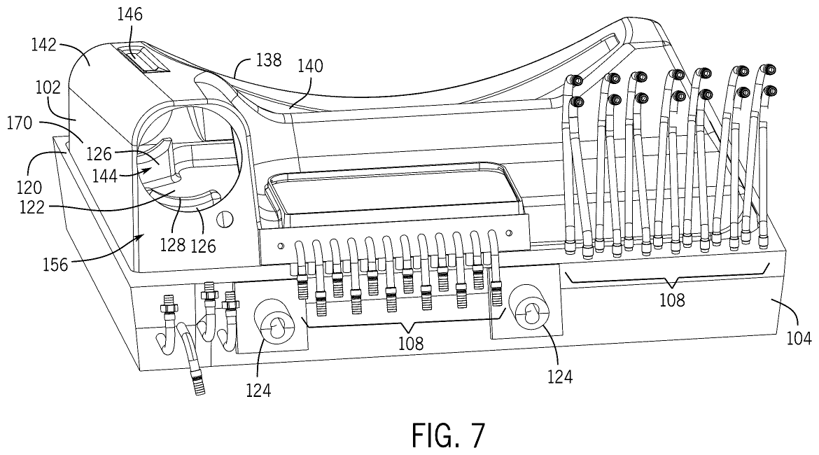

FIG. 7 is a perspective view of the cover 102 fitted onto the cold plate 104. The cover 102 nests inside of the lip 120 and rests on a ledge 150 (e.g. FIG. 4) on the interior side of the lip 120. On the carbonator side of the cold plate 104, the ledge 150 extends from the corners of the lip 120 inwards to the stanchions 126. The cover 102 includes a lower wall 152 (e.g. 6A) that extends about the perimeter of the cover 102 and is configured to engage the inside of the lip 120 on the ledge 150. In examples, the lower wall 152 and the lip 120 may be dimensioned for a resilient or friction fit to connect the cover 102 to the cold plate 104. As can further be seen in FIG. 7, the cover 102 extends above the entirety of the basin 122 and the stanchions 126 and the carbonator housing 142 portion of the cover 102 defines a space above the stanchions 126 to accommodate the carbonator (not depicted) thereon (See e.g. FIGS. 9, 12, and 14.).

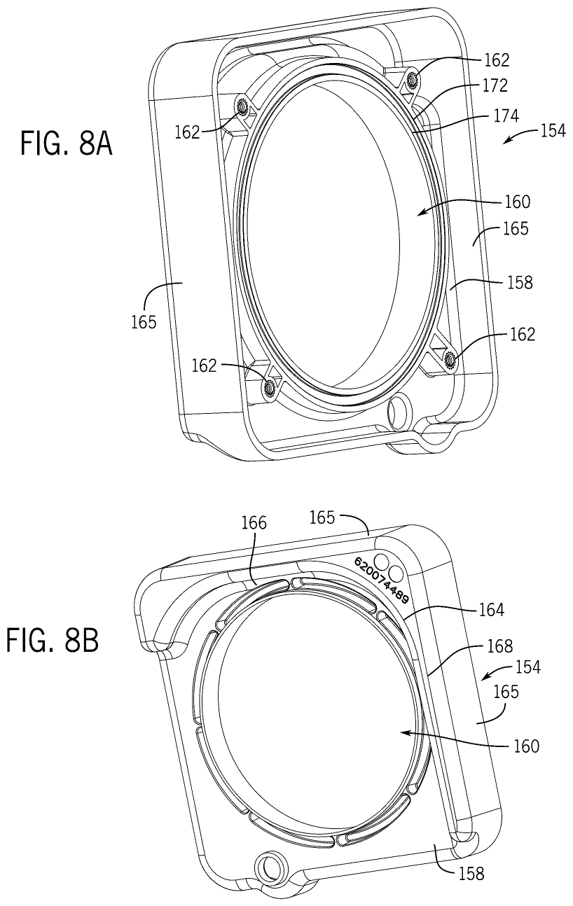

FIG. 8A is a front perspective view of a mounting frame 154 and FIG. 8B is a rear perspective view of the mounting frame 154. The mounting frame 154 is configured to be secured to the cover 102 over the front end 156 of the carbonator housing 142 and into the opening 144 (See e.g. FIG. 7). As described herein, the mounting frame 154 functions to provide connection and securement of the carbonator to cover 102. The mounting frame 154 includes a frame body 158, which is exemplarily square or rectangular, but, as depicted, may have rounded corners, or is contemplated to be of other shapes as well. The frame body 158 includes perimeter walls 165 which extend in a depth dimension between the front side (FIG. 8A) and the back side (FIG. 8B). The mounting frame 154 includes an aperture 160 which is dimensioned to securely fit the cylindrical body 62 of the carbonator 114 therethrough. As will be described in further detail herein, the mounting frame 154 further includes mounting holes 162 configured to receive threaded fasteners. An annular groove 172 extends into the frame body 158 around the aperture 160. An elastomeric gasket 174, exemplarily an o-ring, is seated into the annular groove 172, as will be described in further detail herein.

The back side of the mounting frame 154, as shown in FIG. 8B includes an engagement ridge 164. The engagement ridge 164 extends rearwardly from the frame body 158. The engagement ridge 164 is shaped and dimensioned to match a contour of the cover 102 at the front end 156 of the carbonator housing 142. The engagement ridge 164, thus exemplarily includes a rounded contour 166 at the top of the mounting frame 154 configured to match the exemplary domed shape of the carbonator housing 142. The engagement ridge 164 futher includes a flat wall 168 to exemplarily match the side wall 170 at the carbonator side of the cover 102. The relief valve 117 includes a fitting to which a flexible tube (not depicted) is secured, the flexible tube connects the relief valve through the hold there below which extends through the mounting frame 154 and cover 102 to access the cold plate 104 and cooling chamber 186. Vented gas and/or liquid is deposited into the cooling chamber 186 and cold plate 104. Excess liquid from the relief valve 117 is directed by the cold plate 104 to the drains 124. Additionally, a ridge around the hole as seen in FIG. 8B fits within the corresponding hole in the cover 102 to further orient the mounting frame 154 on the cover 102, at a point at a corner generally opposite the corner intersection of the engagement ridge 164 having the rounded contour 166 and the flat wall 168.

FIG. 9 is a left front perspective view of a cover 102 on a cold plate 104 with the mounting frame 154 connected to the cover 102 and the carbonator 114 received within the mounting frame 154. It is noted that the mounting plate 132 (see FIG. 5A, FIG. 10) is not shown for clarity purposes. The mounting frame 154 is secured to the cover 102, for example by adhesive, ultrasonic welding, or other manners as are known to secure thermoplastic materials. The mounting frame 154 is thus securely attached to the cover 102. In another example, the mounting frame 154 and the cover 102 may be unitarily constructed, which would necessarily remove the need for any specific engagement features between the components. The carbonator 114 is received through the mounting frame 154 with the cylindrical body 62 of the carbonator 114 received through the aperture 160 of the mounting frame. While not shown in FIG. 9, it is recognized from other description that internal to the cover 102, the cylindrical body 62 of the carbonator 114 rests in the respective cradles 128 of the stanchions 126 (See e.g. FIG. 5A).

While the mounting plate 132 is not depicted in FIG. 9 for clarity purposes, fasteners 176 extend through slots 133 in the mounting plate 132 (See e.g. FIG. 5A) and are received within mounting holes 162 of the mounting frame 154. These fasteners 176 secure the mounting plate 132, and the rest of the carbonator 114 to the mounting frame 154 and the cover 102. The corresponding slots 133 in the mounting plate 132 are exemplarily elongated so that there is a degree of freedom or tolerance to ensure that the carbonator is secured to the mounting frame 154 with the carbonator 114 in contact with the stanchions 126. As previously noted, detent 146 and incline 148 help to create an engagement force against the cylindrical body 62 against the stanchions 126. The elastomeric gasket 174 within the annular groove 172 is compressed in contact with a rear face of the mounting plate 132 to form a thermal seal between the mounting frame 154 and the mounting plate 132 radially exterior of the aperture 160.

FIG. 10 is an isolated view similar to FIG. 9, but from the right front side. FIG. 10 further includes the mounting plate 132 not shown in FIG. 9. Additionally, a foam insulation pad 178 is bonded over the mounting plate 132 to provide insulation about the front end of the carbonator 114. The foam insulation pad 178 may have an adhesive backing to secure it to the mounting plate 132 over the fasteners 176. The

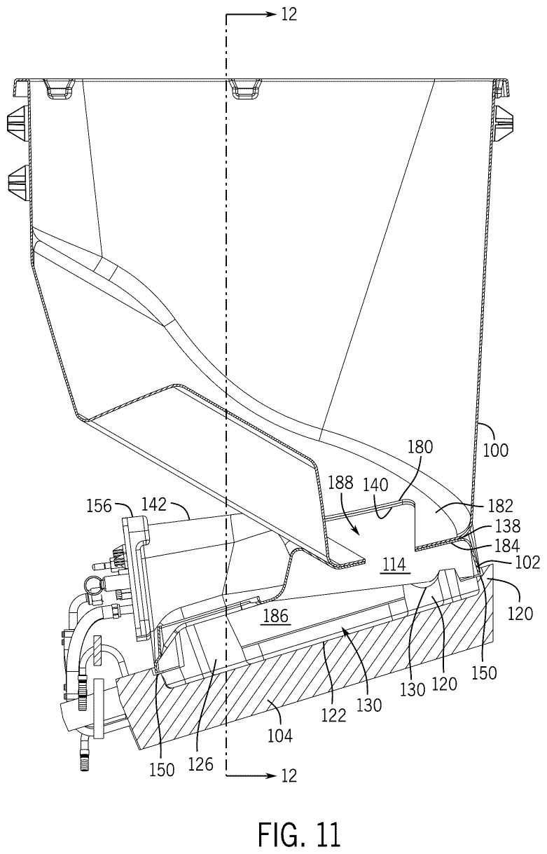

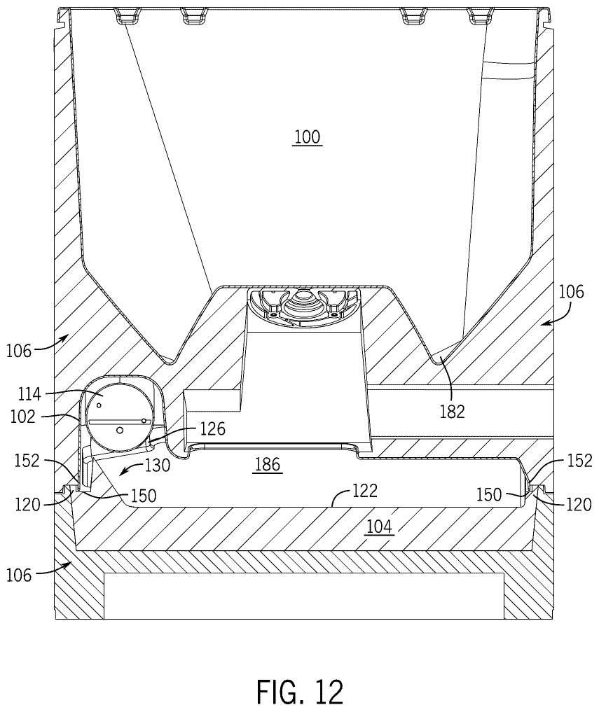

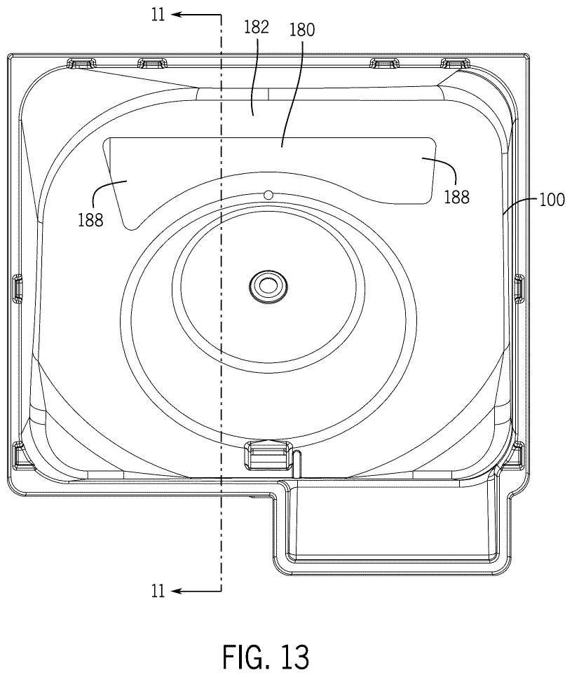

FIG. 11 is a cross-sectional view taken along line 11-11 in FIG. 2 or 13. FIG. 12 is a cross-sectional view taken along line 12-12 of FIG. 11. FIG. 13 is a top view of the hopper 100. Together, these figures depict the structures that influence the distribution of ice within the system, which promotes thermal contact of the ice with the cold plate 104 and the carbonator 114. As can be further seen in FIG. 9, aperture 140 through the cover 102 opens to the basin 122 of the cold plate 104. The hopper 100 includes an aperture 180 (See e.g. FIGS. 11 & 13) that matches the aperture 140 through the cover 102. The bottom 182 of the hopper 100 has a contour that matches the contour of the hopper cradle 138 of the cover 102. The hopper 100 is thus seated in the hopper cradle 138 in a position that aligns the aperture 180 with the aperture 140. The interface 184 between the hopper cradle 138 and the bottom 182 of the hopper 100 is connectively sealed, for example, by adhesive or ultrasonic or other thermoplastic welding, to secure the components of the cover 102 and the hopper 100 mechanically together, but also form a fluid seal between these two components as well.

Cubed ice in the hopper 100 is agitated to keep the ice singulated and to break up bridging. The agitated ice falls through the combined apertures 140/180 onto the cold plate 104, specifically onto the basin 122 of the cold plate 104, but also fills, by gravity the space defined by the cover 102 and the cold plate 104. This cooling chamber 186 below the cover 102 and above the cold plate 104 contains the ice that is used for cooling the cold plate 104, which, in turn, cools the beverages and beverage constituents to be dispensed. The ice within the hopper 100 may be dispensed to a consumer receptacle by the beverage dispenser 10 prior to dispense of the beverage. The cold plate 104 is positioned at an angle within the beverage dispenser 10. The angle of the cold plate 104, is exemplarily less than 45 degrees, or further, 30 degrees or less. The angled cold plate 104 directs ice away from the hopper 100 and towards the lowermost extent of the cooling chamber 186 by way of gravity. This also directs any melted ice water towards the drains 124 previously described.

In a feature distinguishing from previous carbonator configurations, the cooling chamber 186 is extended to encompass the carbonator 114, thus cubed ice in the cooling chamber 186 is further positioned within the extension 130 of the basin 122 below the carbonator 114. The combined apertures 140/180 further define wings 188 which further promote loading and distribution of the cubed ice from the hopper 100 into the cooling chamber 186. Following the curved shape of the hopper cradle 138 and the bottom 182 of the hopper, the wings 188 of the combined apertures 140/180 extend vertically above the cold plate 104 and vertically above a lowermost point of the bottom 182 of the hopper and the apertures 140/180. Height h₁ at the wing 188 towards the carbonator housing 142 is a greater height from the bottom of the cover 102 than the height h₂ to the hopper cradle 138 from the bottom of the cover 102 at the center of the aperture 140. The apertures 140/180 also increase in a depth dimension (d) in the wings 188 towards the sides of the beverage dispenser 10 compared to the middle of the apertures 140/180, increasing the opening area of the apertures 140/180 towards the sides of the beverage dispenser 10 and cold plate 104. The apertures 140/180 are narrowest in the depth dimension d₁ at the middle of the apertures 140/180 and larger in the depth dimension d₂, d₃ at the wings 188. The depth d₂ of the wing 188 at the carbonator housing 142 may be greater than the depth dimension d₃ at the other wing 188, although both d₂ and d₃ are greater than d₁.

As seen in FIG. 10, the wings 188, having the height and depth extensions as described above, expose the cylindrical body 62 of the carbonator 114 and the extension 130 of the basin 122, as well as the cove 136 between the cold plate 104 and the carbonator 114. This promotes ice from the hopper to accumulate in the cove 136 and about the body 62 of the carbonator 114. The carbonator housing 142, as a part of defining the cooling chamber 186, opens into the rest of the cooling chamber 186 which exposes the cylindrical body 62 of the carbonator 114 to direct contact with the cubed ice in the cooling chamber 186. The wing 188 on the carbonator side further exposes the cylindrical body 62 of the carbonator 114 to the cubed ice. The wings 188 of the combined aperture effectively increase the operable vertical height of the cooling chamber 186 which can be filled with cubed ice from the ice hopper 100 by way of gravity and agitation. Increased opening area of the apertures 140/180 and vertical height thereof towards the sides of the cold plate 104 facilitate distribution of ice across the entire basin 122. The angle of the cold plate 104 further distributes ice on the basin 122 away from the apertures 140/180.

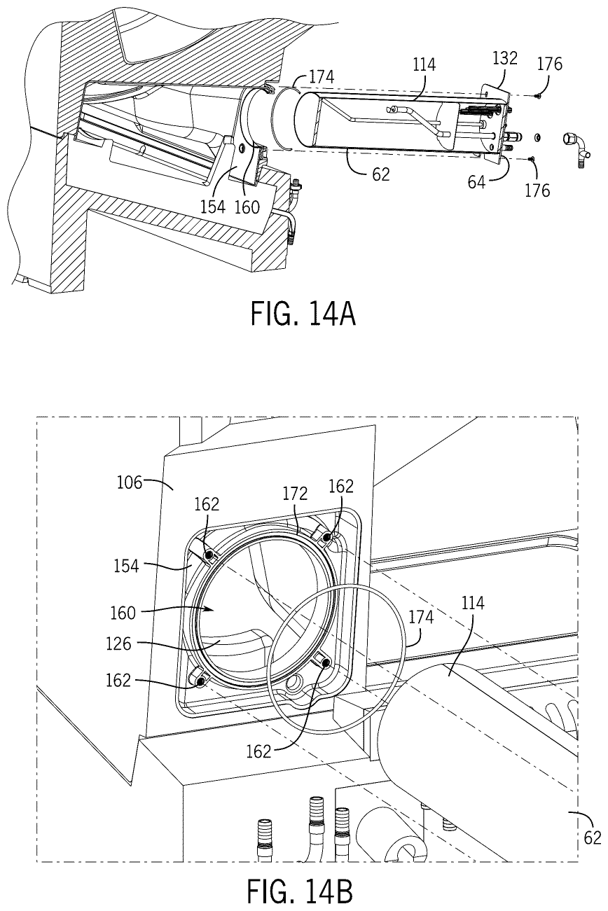

FIGS. 14A and 14B present two views depicting insertion of the carbonator 114 into the carbonator housing 142 of the cover 102. The cylindrical body 62 is inserted through the aperture 160 of the mounting frame 154. The elastomeric gasket 174 is seated within the annular groove 172 in the mounting frame 154 and forms a seal about the aperture 160 against the mounting plate 132. Fasteners 176 are inserted through slots in the mounting plate 132 and into mounting holes 162 to secure the carbonator 114 to the mounting frame 154.

The combined system of the hopper 100, cover 102, and cold plate 104 are further insulated and secured together by polyurethane (PU) foam insulation 106. In previous beverage dispenser constructions, the carbonator was secured in place exterior of the cover 102 with the foam insulation. This presented challenges of ensuring thermal contact between the stanchions and the carbonator and the carbonator could not be replaced without destroying or damaging the foam insulation. With the construction as disclosed herein, improved cooling of the carbonator 114 is achieved and the PU foam insulation is not in direct contact with the carbonator, thus facilitating the in-field replacement of the carbonator. In-field removal of the carbonator may be achieved by disconnecting the plumbing of the water inlet, water outlet, carbon dioxide inlet and the relief valve outlet tube. Next, the fasteners 176 securing the mounting plate 132 to the mounting frame 154 are removed. The carbonator 114 can then be slid directly out of the carbonator housing 142 through the aperture 144/160. This is done without disruption of the insulation 106 surrounding the hopper 100, cover 102, and cold plate 104. The carbonator 114 may then be serviced or replaced. Additionally, once the carbonator 114 is removed access is provided to the cold plate 104, particularly to the basin 122 and the stanchions 126 of the cold plate 104 through the aperture 144/160, for cleaning, service, maintenance, or remanufacturing.

Citations to a number of references are made herein. The cited references are incorporated by reference herein in their entireties. In the event that there is an inconsistency between a definition of a term in the specification as compared to a definition of the term in a cited reference, the term should be interpreted based on the definition in the specification.

In the above description, certain terms have been used for brevity, clarity, and understanding. No unnecessary limitations are to be inferred therefrom beyond the requirement of the prior art because such terms are used for descriptive purposes and are intended to be broadly construed. The different systems and method steps described herein may be used alone or in combination with other systems and methods. It is to be expected that various equivalents, alternatives and modifications are possible within the scope of the appended claims.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A beverage dispenser comprising:
a cold plate comprising a plurality of fluid lines running therethrough;
a cover comprising a carbonator housing and a hopper cradle, a cover aperture extending through the hopper cradle of the cover, the cover and cold plate defining a cooling chamber;
an ice hopper comprising a hopper aperture, wherein the ice hopper is connected to the cover at the hopper cradle with the hopper aperture in alignment to the cover aperture and configured for cubed ice in the ice hopper to fall through the hopper aperture and the cover aperture onto the cold plate; and
a carbonator received through the cover into the carbonator housing.

2. The beverage dispenser of claim 1, wherein the cold plate further comprises a front stanchion and a rear stanchion, the front stanchion and the rear stanchion are integrally formed with the cold plate and configured to engage a body of the carbonator, the front stanchion and the rear stanchion being within the carbonator housing defined by the cover.

3. The beverage dispenser of claim 2, wherein the cold plate defines a basin configured to receive cubed ice thereon.

4. The beverage dispenser of any of claim 3, further comprising an extension of the basin that defines a cove between the front stanchion and the rear stanchion.

5. The beverage dispenser of claim 4, wherein the cold plate comprises a lip that defines an operative perimeter of the basin, wherein the cover is configured to engage the lip to define the cooling chamber.

6. The beverage dispenser of claim 5, wherein the cold plate comprises a ledge that extends interior of the lip and a lower wall of the cover is configured to rest on the ledge.

7. The beverage dispenser of claim 6, wherein the ledge extends interior of the lip to the front stanchion and the rear stanchion and defines a basin with a cove between the front stanchion and the rear stanchion.

8. The beverage dispenser of claim 2, wherein the cover comprises an opening through the cover into the carbonator housing, the carbonator comprises a body and a top end, wherein the body is received within the cooling chamber, and cover comprises a detent extending interiorly into the carbonator housing, wherein the detent is configured to engage the body of the carbonator to place the body of the carbonator into engagement with the front stanchion and the rear stanchion.

9. The beverage dispenser of claim 8, wherein the carbonator comprises a mounting plate secured to the top end and further comprising a mounting frame secured to an exterior of the carbonator housing about the opening through the cover into the carbonator housing, wherein the opening is configured to receive the body of the carbonator through the opening and the mounting plate is secured to the mounting frame.

10. The beverage dispenser of claim 1, wherein the carbonator comprises a body and a top end, wherein the body is received within the cooling chamber and the top end is exposed through the cover.

11. The beverage dispenser of claim 10, wherein the carbonator comprises a water inlet through the top end, a gas inlet through the top end, and a carbonated water outlet through the top end.

12. The beverage dispenser of claim 11, wherein the carbonated water outlet is fluidly connected to a fluid line of the plurality of fluid lines of the cold plate.

13. The beverage dispenser of claim 10, wherein the carbonator comprises a mounting plate secured to the top end and wherein the cover comprises an opening through the cover into the carbonator housing, the beverage dispenser further comprising:
a mounting frame secured to an exterior of the carbonator housing about the opening through the cover into the carbonator housing, wherein the opening is configured to receive the body of the carbonator through the opening and the mounting plate is secured to the mounting frame.

14. The beverage dispenser of claim 13, wherein the mounting frame comprises an aperture concentrically aligned with the opening and configured to receive the body of the carbonator therethrough and an annular groove about the aperture, and the beverage dispenser comprises an elastomeric gasket seated within the annular groove, the elastomeric gasket configured to engage the mounting plate to create a seal between the mounting frame and the mounting plate.

15. The beverage dispenser of claim 14, wherein the mounting plate is secured to the mounting frame by at least one fastener.

16. The beverage dispenser of claim 14, further comprising an insulation pad secured to an exterior face of the mounting plate.

17. The beverage dispenser of claim 10, wherein the hopper cradle is curved across a lateral dimension and the cover aperture and the hopper aperture increase in a height vertically above the cold plate in a wing laterally towards the carbonator.

18. The beverage dispenser of claim 17, wherein the cover aperture and the hopper aperture increase in a depth dimension in the wing laterally towards the carbonator.

19. The beverage dispenser of claim 18, wherein the cold plate further comprises a front stanchion and a rear stanchion, the front and rear stanchions integrally formed with the cold plate and configured to engage a body of the carbonator, the front stanchion and the rear stanchion being within the carbonator housing defined by the cover;
wherein the cold plate defines a basin configured to receive cubed ice thereon, and the basin having an extension that defines a cove between the front stanchion and the rear stanchion.

20. The beverage dispenser of claim 19, wherein the wing is configured to expose the body of the carbonator and the cove to ice from the hopper through the cover aperture and the hopper aperture.
